(19) United States
(12) Patent Application Publication
(10) Pub. No.: US 2025/0055661 A1
(43) Pub. Date: Feb. 13, 2025

(54) SYSTEM AND METHOD FOR BEAM HANDLING WHEN GNB SWITCHES BETWEEN ANTENNA/PANEL CONFIGURATIONS

(71) Applicant: Samsung Electronics Co., Ltd., Gyeonggi-do (KR)

(72) Inventors: Mohamed Mokhtar Gaber Moursi AWADIN, San Diego, CA (US); Jung Hyun BAE, San Diego, CA (US)

(73) Assignee: Samsung Electronics Co., Ltd., (omitted)

(21) Appl. No.: 18/797,091

(22) Filed: Aug. 7, 2024

Related U.S. Application Data
(60) Provisional application No. 63/518,475, filed on Aug. 9, 2023.

(51) Int. Cl. H04L 5/14; H04L 5/00; H04W 72/231

(52) U.S. Cl. CPC H04L 5/14; H04L 5/0051; H04L 5/0053; H04L 5/0094; H04L 5/0096; H04W 72/231

(57) ABSTRACT

A system and a method are disclosed for determining a quasi co-located (QCL) source reference signal (RS) to receive a target signal or channel. The method includes receiving antenna indicator information indicating one or more first antenna configurations and one or more second antenna configurations from a base station; identifying a first set of symbols at which the one or more first antenna configurations are applied and a second set of symbols at which the one or more second antenna configurations are applied; and receiving the target signal or channel using a version of the QCL source RS at a time instance based on whether the time instance occurs in the first set of symbols or the second set of symbols.

### CROSS-REFERENCE TO RELATED APPLICATION

This application claims the priority benefit under 35 U.S.C. § 119(e) of U.S. Provisional Application No. 63/518,475, filed on Aug. 9, 2023, the disclosure of which is incorporated by reference in its entirety as if fully set forth herein.

### TECHNICAL FIELD

The disclosure generally relates to beam handling in next-generation NodeB (gNB) systems. More particularly, the subject matter disclosed herein relates to improvements to handling beam configurations and antenna or panel configurations in sub-band full duplex (SBFD) and non-SBFD operations.

### SUMMARY

In new radio (NR) systems, a gNB can configure user equipment (UE) with multiple transmission configuration indication (TCI) states via higher-layer signaling. Each TCI state includes one or more reference signals (RSs), which can serve as quasi co-location (QCL) source RSs for target signals or channels. These configurations aim to optimize the performance of uplink (UL) and downlink (DL) transmissions, ensuring efficient communication between gNB and UE. Previous solutions have focused on static antenna configurations where antennas used for DL transmission in DL symbols or flexible symbols do not vary across time. These methods attempt to maintain optimal performance by ensuring that the QCL parameters for target signals or channels are consistently derived from the same beams. However, these solutions do not address the dynamic changes in antenna configurations that occur in SBFD operations, where the gNB uses only some of its antennas for DL transmission to avoid increased complexity.

One issue with prior approaches is that they do not account for the variability in beam configurations when the gNB switches between SBFD symbols and non-SBFD symbols. This variability may lead to ambiguity in determining which beam should be used for deriving the QCL parameters, potentially resulting in suboptimal performance and increased interference.

To overcome these types of issues, systems and methods are described herein for handling dynamic antenna configurations in SBFD operations. For example, embodiments disclosed herein introduce the concept of identifying effective RSs for QCL source RSs in one or more TCI states.

According to an embodiment, a periodic (P)/semi-persistent (SP) RS may be divided into multiple effective RSs based on the antenna configurations used during transmission. Some embodiments may include implicitly or explicitly indicating the time patterns for different effective RSs through higher-layer signaling. Additionally, some embodiments may involve activating multiple sets of TCI states, allowing for different QCL types (A, B, C, or D) to be configured separately.

The above approaches improve on previous methods because they provide a flexible and adaptive framework for managing dynamic antenna configurations, increasing the likelihood that the appropriate beam configurations are used for each transmission scenario, thereby reducing interference and optimizing signal quality.

In an embodiment, a method for determining a QCL source RS to receive a target signal or channel is provided. The method includes receiving antenna indicator information indicating one or more first antenna configurations and one or more second antenna configurations from a base station; identifying a first set of symbols at which the one or more first antenna configurations are applied and a second set of symbols at which the one or more second antenna configurations are applied; and receiving the target signal or channel using a version of the QCL source RS at a time instance based on whether the time instance occurs in the first set of symbols or the second set of symbols.

In an embodiment, a UE comprises a memory device, and a processor configured to execute instructions stored on the memory device. The instructions cause the processor to receive antenna indicator information indicating one or more first antenna configurations and one or more second antenna configurations from a base station; identify a first set of symbols at which the one or more first antenna configurations are applied and a second set of symbols at which the one or more second antenna configurations are applied; and receive a target signal or channel using a version of the QCL source RS at a time instance based on whether the time instance occurs in the first set of symbols or the second set of symbols.

### BRIEF DESCRIPTION OF THE DRAWING

In the following section, the aspects of the subject matter disclosed herein will be described with reference to exemplary embodiments illustrated in the figures, in which:

FIG. 1 illustrates a transmitting device or a receiving device in a communication system, according to an embodiment;

FIG. 2 illustrates configurations of antenna panels being used by a gNB, according to an embodiment;

FIGS. 3A-3D illustrate four scenarios of SBFD operation compared to legacy operators using static time division duplexing (TDD), according various embodiments;

FIG. 4 is a resource grid illustrating an example of a periodic/semi-persistent (P/SP) channel state information-RS (CSI-RS) with a periodicity equal to 4 slots, according to an embodiment;

FIG. 5 is a block diagram illustrating conditions in which a TCI state is interpreted relative to the effective CSI-RS rather than the CSI-RS itself, according to an embodiment;

FIG. 6 is a diagram illustrating how the effective CSI-RS associated with different antenna or panel configurations is determined, according to an embodiment;

FIG. 7 is a diagram illustrating how the effective QCL source RS is determined based on a configured time window pattern, according to an embodiment;

FIG. 8 is a resource grid illustrating an example of determining the effective QCL source RS for the reception of physical downlink shared channel (PDSCH) based on an occupied symbol type, according to an embodiment;

FIG. 9 is a diagram illustrating how the effective QCL source RS for control resource set (CORESET) monitoring is determined, according to an embodiment;

FIGS. 10A-10B are diagrams illustrating how the QCL assumption of PDSCH scheduled with physical downlink control channel (PDCCH) is determined in a case in which a time offset is greater than a threshold, according to various embodiments;

FIGS. 11-12 are diagrams illustrating how the QCL assumption of the PDSCH scheduled with PDCCH is determined in a case in which a time offset is less than a threshold, according to various embodiments;

FIG. 13 is a resource grid illustrating an example of interpreting a TCI field based on a time location of a PDSCH occasion, according to an embodiment;

FIG. 14 is a resource grid illustrating a timeline for applying a second set of TCI states, according to an embodiment;

FIG. 15 is a flowchart illustrating a method for determining a QCL source RS to receive a target signal or channel, according to an embodiment;

FIG. 16 is a block diagram of an electronic device in a network environment, according to an embodiment; and

FIG. 17 is a system including a UE and a base station gNB, in communication with each other, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and case of discussion only; it does not imply that the construction or architectural details of such components or units are the same across all embodiments or such commonly-referenced parts or modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

“Module” as used herein refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

“Effective QCL source RS” as used herein refers to a specific RS instance or instances that a UE determines and uses for configuring a target signal or channel based on information such as QCL relationships and time domain locations. Some examples of “effective QCL source RS” are effective CSI-RS instances determined for specific time intervals or antenna configurations.

“Effective TCI state” as used herein refers to a TCI state that accounts for different QCL types and antenna configurations over time, used to interpret control information for signal transmission and reception. Some examples of “effective TCI state” are TCI states applied during different operational modes like full duplex or energy-saving modes.

“Instance” (or “time instances”) as used herein refers to a specific occurrence or transmission of a signal or RS within its configured time pattern. The term refers to a transmission occasion of a periodic or semi-persistent CSI-RS. Some examples of “instance” are individual transmissions of a periodic CSI-RS or a scheduled PDSCH transmission at a particular time slot.

“Time domain location” as used herein refers to time intervals or symbols within a communication frame where certain configurations or operations are applied. Some examples of “time domain location” are the time slots for SBFD symbols and non-SBFD symbols, or the time intervals associated with different antenna configurations. The term encompasses the temporal positioning of these configurations as indicated by the base station or derived by the UE.

“Antenna indicator information” as used herein refers to control signaling, such as DCI or other control messages, that provides details regarding the configuration and usage of antennas for signal transmission and reception. “Antenna indicator information” can be any information that provides an indication of where or when one or more antenna configurations may change. The indication can be an explicit indication (e.g., an indication for a time location corresponding to an antenna configuration), or an implicit indication (e.g., an indication for SBFD symbols corresponding to an antenna configuration and/or another indication for non-SBFD symbols corresponding to another antenna configuration). Some examples of “antenna indicator information” are DCI messages specifying beamforming parameters, control signals indicating antenna switching patterns, higher layer signaling conveying antenna configuration updates for full duplex or energy-saving operations, and/or SBFD configuration information that indicates a location of SBFD symbols and/or non-SBFD symbols.

“Version” as used herein refers to a specific form of the QCL source RS that is determined and used by a UE based on various configurations and conditions. A “version” may refer to multiple “versions”, and some examples of “version” are the effective QCL source RS instances, such as the 1st effective RS and 2nd effective RS, or the QCL source RS determined from a first or second active set of TCI states.

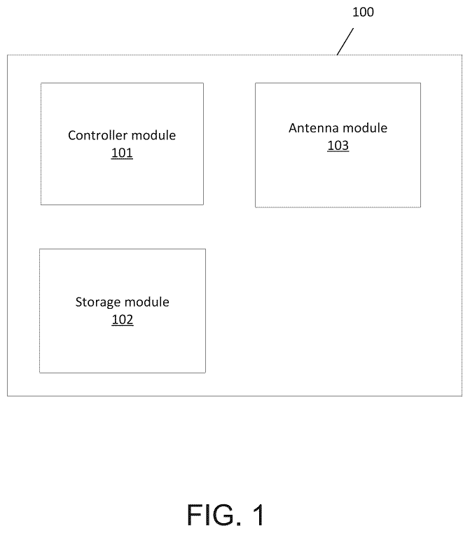

FIG. 1 illustrates a transmitting device or a receiving device in a communication system, according to an embodiment.

Referring to FIG. 1, the device 100 may be a UE (e.g., a client device) or a gNB and includes a controller module 101 (e.g., a processor), a storage module 102, and an antenna module 103.

The controller module 101, storage module 102, and antenna module 103 may be structural components to facilitate efficient and accurate transmission or reception of wireless signals. As described herein, the wireless signals that are transmitted may be compressed (e.g., encoded) prior to transmission and reassembled (e.g., decoded) after reception. The device 100 may include all of the structural components necessary to compress, transmit, receive, and/or decompress the wireless signals.

The controller module 101 may include at least one processor and may execute instructions that are stored in the storage module 102. For example, the controller module 101 may execute instructions for performing compression, decompression, and signaling techniques described herein. In addition, the controller module 101 may include a digital signal processor (DSP) for performing signal processing on a signal. The DSP may include one or more processing modules for functions such as synchronization, equalization, and demodulation. The processing modules may be implemented using one or more DSP techniques, such as fast Fourier transform (FFT), inverse FFT (IFFT), and digital filtering. Additionally or alternatively, the controller module 101 may include an application processor for running user applications on the device 100, such as web browsers, video players, and other software applications. The application processor may include one or more processing units, memory devices, and input or output interfaces.

The storage module 102 may include transitory or non-transitory memory storing instructions that, when executed, cause the controller module 101 to perform steps to execute signaling techniques described herein. In addition, the storage module 102 may include a protocol stack for implementing communication protocols. The protocol stack may include one or more layers, such as a physical layer, a medium access control (MAC) layer, a radio link control (RLC) layer, and a packet data convergence protocol (PDCP) layer.

The antenna module 103 may include one or more antennas for wirelessly transmitting and receiving signals to a base station, UE or another device. For example, the antenna module 103 may receive a signal transmitted by a base station and convert it into an electrical signal.

The device 100 may be a receiver of a wireless communication system (e.g., the UE in 5G NR system) in DL. Additionally or alternatively, the UE may modulate (e.g., compress) and transmit signals to the gNB. Also, the device 100 may also transmit a signal via the antenna module 103 and, therefore, may be a transmitter or a gNB.

In NR, the gNB can configure the UE with multiple TCI states via higher layer signaling where each TCI state has its own identification (herein referred to as “Id”), and one or two RSs. Those RSs can be considered as a QCL source RS for the target channel or signal. The target channel may herein refer to a demodulation RS (DMRS) port of a PDCCH, a DMRS port of a PDSCH, a DMRS of a physical uplink shared channel (PUSCH), a DMRS of physical uplink control channel (PUCCH), etc., and the target signal may refer to a CSI-RS, sounding RS (SRS), etc.

The QCL source RS and the target channel or RS may be herein referred to as QCLed. The QCL source RS and the target channel or RS may share some common channel properties such as Doppler shift, Doppler spread, average delay, delay spread, and/or a spatial Rx parameter. In NR, four groups of the channel properties are defined, referred to as: typeA: {Doppler shift, Doppler spread, average delay, delay spread}, typeB: {Doppler shift, Doppler spread}, typeC: {Doppler shift, average delay}, and typeD: {Spatial Rx parameter}. As part of the TCI state configurations, the gNB may configure the qcl-Type to indicate which set of channel properties is shared between the QCL source RS(s) and the target signal or channel. Accordingly, the TCI state may indicate a plurality of QCL source RSs so that the gNB may configure some channel properties of the target signal or channel based on a first QCL source RS, while other channel properties of the target signal or channel may be based on a second QCL source RS.

Out of the configured TCI state(s), the gNB may down select a small set of TCI to be used for dynamic scheduling. The selection may be conducted by a medium access control-control element (MAC-CE) which maps the code points of a TCI field to one or two TCI states. This mapping may be applied a predefined time (e.g., 3 milliseconds (ms)) after the transmission of the automatic repeat request-acknowledgement (HARQ-ACK) of the PDSCH carrying MAC-CE. Specifically, the indicated mapping between the code points of the TCI field to one or two TCI states may be applied from the first slot that is n+3ₛₗₒₜ^{subframe,μ} where μ is the subcarrier spacing (SCS) configuration for the PUCCH with HARQ-ACK information of PDSCH carrying the MAC-CE and n is the slot in which PUCCH would be transmitted.

Also, a TCI field may not be present for fallback downlink control information (DCI), e.g., DCI format 1_0. For non-fallback DCI, e.g., DCI format 1_1 and 1_2, the presence of the TCI field may be configurable by higher layer parameters, e.g., tci-PresentInDCI and tci-PresentDCI-1-2. For example, the size of the field may be fixed in DCI format 1_1, but configurable for DCI format 1_2.

If the TCI field is not present in the DCI for any reason and the time gap/offset between the reception of the DL DCI and the corresponding PDSCH of a serving cell is equal to or greater than a threshold timeDurationForQCL, the UE may determine that the PDSCH has the same QCL properties as the corresponding PDCCH. For example, the UE may determine that PDCCH and the corresponding PDSCH are transmitted using the same beam when the time gap between them is larger than timeDurationForQCL. The value of timeDurationForQCL may be determined based on UE capability reporting.

On the other hand, if the TCI field is present in the scheduling DCI and the time gap/offset between the reception of the DL DCI and the corresponding PDSCH of a serving cell is equal to or greater than a threshold timeDurationForQCL, the UE may determine that the QCL source RS corresponding to the indicated or configured TCI is QCLed with the target channel or RS with respect to a QCL-type associated with the indicated or configured TCI.

If the time gap/offset between the reception of the DL DCI and the corresponding PDSCH of a serving cell is less than a threshold timeDurationForQCL, and at least one of the configured TCI states is QCL “typed” (e.g., types A, B, C or D), the indicated TCI state by the PDCCH may not be used. Therefore, the UE may need a procedure to determine the QCL assumption, which refers to the QCL source RS and QCL type that will be applied to receive the target signal or channel, based on one of the following assumptions (a)-(d):
(a): The UE may determine that PDSCH is QCLed with QCL a source RS that is the same as the one used for PDCCH reception in the CORESET associated with a monitored search space with the lowest controlResourceSetId in the latest slot. If it occurs that a PDCCH overlap with PDSCH is at least one symbol and they have different QCL “typeD”, the UE prioritizes the reception of PDCCH.
(b): If a multi-DCI multi-transmission reception point (TRP) is used, i.e., different CORESETs have different values of coresetPoolIndex, and enableDefaultTCI-StatePerCoresetPoolIndex is configured, the aforementioned procedure may be applied per coresetPoolIndex. Specifically, the UE may determine that PDSCH is QCLed with the QCL source RS that is the same as the one used for PDCCH reception in the CORESET associated with a monitored search space with the lowest controlResourceSetId in the latest slot among CORESETs, which are configured with the same value of coresetPoolIndex as PDCCH scheduling that PDSCH. If it occurs that a PDCCH overlap with PDSCH is at least one symbol, they have different QCL “typeD” and they are associated with same value of coresetPoolIndex, the UE prioritizes the reception of PDCCH.
(c): If single-DCI multi-TRP is used, i.e., at least one TCI codepoint indicates two TCI states, and enableTwoDefaultTCI-States is configured, two or more default TCI states should be determined. That is, in a single-DCI multi-TRP operation, two or more default TCI states may be needed to determine the applied TCI state for different (or repeated) PDSCH repetitions. The repeated PDSCHs can be in different slots (inter-slot repetition), or PDSCH repetitions can be within the same slot (intra-slot repetition). In this operation mode, the two or more default TCI states may be determined based on the lowest codepoint among the TCI codepoints containing two different TCI states. For inter-slot repetition, i.e., repetitionNumber is configured, or for intra-slot repetition, i.e., repetitionScheme is set to “tdmSchemeA”, and the gap/offset between the reception of the DL DCI and the first PDSCH transmission occasion is less than the threshold timeDurationForQCL, the applied TCI state(s) to the repeated PDSCHs is based on a regular operation depending on the repetition scheme being inter-slot or intra-slot repetition, but using the two or more default TCI states instead of an indicated TCI state(s). Specifically, the mapping of the TCI state to PDSCH transmission occasions may be determined by replacing the indicated TCI state(s) with the TCI state corresponding to the lowest codepoint among the TCI codepoints containing two different TCI states based on the activated TCI state in the slot with the first PDSCH transmission occasion.

Similarly, the UE prioritizes the reception of PDCCH overlapping in at least one symbol with one of the PDSCH repetitions when they have different QCL-TypeD.
(d): If none of the configured TCI states has QCL “typeD”, the indicated TCI state should be applied regardless of the time offset.

Similarly, for aperiodic CSI-RS, the TCI state of the triggered aperiodic-CSI-RS (AP-CSI-RS) may be configured by higher layer signaling for each AP-CSI-RS associated with the CSI triggering state. If a scheduling gap/offset between the last symbol of the triggering PDCCH and the first symbol of the AP-CSI-RS is smaller than a particular threshold, the threshold value may be reported by the UE, i.e., beamSwitchTiming, and the scheduling gap/offset may take values {14, 28, 48}, 48 when the UE provides beamSwitchTiming-r16. In addition, enableBeamSwitchTiming may be provided and the non-zero power (NZP)-CSI-RS-ResourceSet may be configured with the higher layer parameter repetition set to “off”, or smaller than the UE reported threshold beamSwitchTiming-r16, when enableBeamSwitchTiming is provided and the NZP-CSI-RS-ResourceSet is configured with the higher layer parameter repetition set to “on”.

If multi-DCI multi-TRP is used, i.e., different CORESETs have different values of coresetPoolIndex, and enableDefaultTCI-StatePerCoresetPoolIndex may be configured, if the AP-CSI-RS overlaps with another DL signal, the UE may apply the TCI of the other DL signal. The DL signal may be PDSCH scheduled with the same coresetPoolIndex used for triggering the AP-CSI-RS and the scheduling gap for PDSCH may be larger than or equal to timeDurationForQCL. Additionally or alternatively, the DL signal may be another aperiodic CSI-RS triggered PDCCH associated with the same coresetPoolIndex with a gap larger than beamSwitchTiming when reported to be {14, 28, 48} and enableBeamSwitchTiming is not provided. Additionally or alternatively, the DL signal may be another aperiodic CSI-RS triggered PDCCH associated with the same coresetPoolIndex with a gap larger than 48 when the reported value of beamSwitchTiming-r16 is one of the values {224, 336} and enableBeamSwitchTiming is provided, for periodic CSI-RS or semi-persistent CSI-RS.

On the other hand, if AP-CSI-RS does not overlap with other signals, similar to PDSCH reception, the UE may apply QCL parameters of the CORESET associated with a monitored search space with the lowest controlResourceSetId in the latest slot among CORESETs, which are configured with the same value of coresetPoolIndex as the PDCCH triggering that AP-CSI-RS.

If single-DCI multi-TRP is used, i.e., at least one TCI codepoint indicates two TCI states, and enableTwoDefaultTCI-States is configured, if the AP-CSI-RS overlaps with another DL signal, the UE may apply the TCI of the other DL signal. The DL signal may be scheduled PDSCH, and the scheduling gap for PDSCH may be equal to or greater than timeDurationForQCL. Additionally or alternatively, the DL signal may be another aperiodic CSI-RS with a gap larger than beamSwitchTiming when reported to be {14, 28, 48} and enableBeamSwitchTiming is not provided. Additionally or alternatively, the DL signal may be another aperiodic CSI-RS with a gap larger than 48 when the reported value of beamSwitchTiming-r16 is one of the values {224, 336} and enableBeamSwitchTiming is provided for a periodic CSI-RS or semi-persistent CSI-RS. If there is a PDSCH indicated with two TCI states in the same symbol(s) as the CSI-RS, the UE may apply the first TCI state of the two TCI states when receiving the aperiodic CSI-RS.

On the other hand, if AP-CSI-RS does not overlap with another DL signal, similar to PDSCH reception, the UE may apply the first one of two TCI states corresponding to the lowest TCI codepoint among those mapped to two TCI states and applicable to the PDSCH within the active bandwidth part (BWP) of the cell in which the CSI-RS is to be received when receiving the aperiodic CSI-RS.

If the operation is not multi-DCI multi-TRP or single-DCI multi-TRP, or if the AP-CSI-RS overlaps with another DL signal, the UE may apply the TCI of the other DL signal. The DL signal may be scheduled PDSCH, and the scheduling gap for PDSCH may be larger than or equal to timeDurationForQCL for a periodic CSI-RS, a semi-persistent CSI-RS, or another aperiodic CSI-RS depending on whether repetition is “on” or “off”.

If the operation is not multi-DCI multi-TRP or single-DCI multi-TRP and AP-CSI-RS does not overlap with another DL signal, similar to PDSCH, the UE may apply QCL parameters of the CORESET associated with a monitored search space with the lowest controlResourceSetId in the latest slot among CORESETs.

If the gap/offset is greater than a threshold which depends whether repetition is “on” or “off”, the configured TCI state may be applied.

The antennas and panels used at the gNB may change over different time instances.

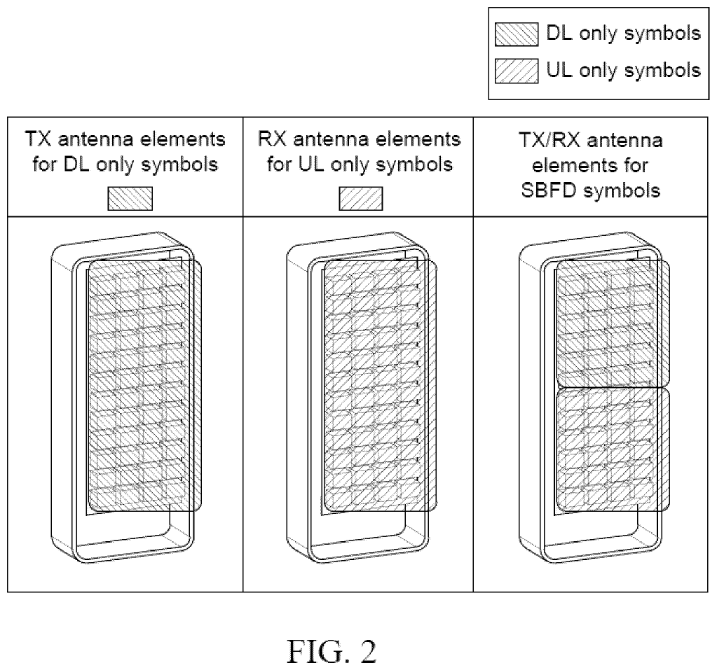

FIG. 2 illustrates configurations of antenna panels being used by a gNB, according to an embodiment.

Referring to FIG. 2, when operating in full duplex mode, the antennas and panels may change depending on whether the gNB intends to concurrently transmit and receive in SBFD symbols or slots, only transmit in DL symbols or slots, or only receive in UL symbols or slots. For example, the gNB may use two panels for transmission in regular DL symbols or slots and, in SBFD symbols or slots, use one panel for DL and another panel for UL for concurrent transmission and reception. Similarly, for network energy saving, the gNB may perform spatial domain adaptation by turning off some antenna ports or antennas associated with particular ports. In either case, the transmit beam may change.

This variability can be problematic when such signals are used as a source QCL RS and are configured as periodic or semi-persistent since different beams may be applied at different time instances, making it unclear for a UE to determine which beam should be used. Moreover, in some situations, the gNB may not indicate which beam to apply for the reception of a physical signal or channel, or it may indicate a beam that is not actually used.

For beam failure recovery RS(s), there can be two possibilities for providing a beam failure detection (BFD) RS. The CSI-RS or synchronization signal block (SSB) can be explicitly configured for detecting beam failure. If the transmission beam of CSI-RS or SSB at the gNB changes from one instance to another, it can be challenging for the UE to determine which beam to use for BFD. For the implicit RS based on the TCI state of the PDCCH, determining the applicable beam can also be challenging to discern. For CORESET_0, which is configured by a master information block (MIB), and remaining minimum system information (RMSI) PDSCH, the QCL source RS may be the associated SSB with respect to typeA and typeD. Therefore, if the beam used for transmitting SSB changes, it may be unclear which beam should be used for the reception of PDCCH in CORESET_0 and the corresponding RMSI PDSCH.

For CORESETs other than CORESET_0 (e.g., CORESET_x), if no TCI is indicated, the UE may use the SSB that was used during the initial access as the QCL source RS. Thus, if the beam used for transmitting SSB changes, it may be unclear which beam should be used for the reception of PDCCH in CORESET_x. For CORESET_x, the UE may determine that the CSI-RS or SSB indicated via MAC-CE activates the associated TCI state. If the beam used for CSI-RS or SSB changes, it may be unclear which beam should be applied. This same issue applies to MAC-CE activating TCI states in multiple component carriers (CCs).

For a PDSCH scheduled with a time gap greater than the threshold, but where MAC-CE did not activate any TCI state, the UE may use the SSB that was used during the initial access as the QCL source RS. Therefore, if the beam used for transmitting SSB changes, it may be unclear which beam should be used for the reception of this PDSCH. For fallback DCIs, or DCIs without a TCI state field, and when the PDSCH is scheduled with a time gap greater than the threshold, the UE may use the same beam as the PDCCH. Therefore, if the PDCCH and PDSCH occur at different time instances where the gNB has to use different beams, it may be unclear what the UE should assume regarding the transmission beam of PDSCH.

When the time gap between the PDSCH and the scheduling PDCCH is less than the threshold, the UE may apply the beam of the CORESET with the lowest Id among the monitored ones in the latest slot. If enableDefaultTCI-StatePerCoresetPoolIndex is configured, the same rule may be applied with respect to the CORESETs in the same CORESET pool index. If enableTwoDefaultTCI-States is configured, the UE may apply the lowest codepoint among the TCI codepoints containing two different TCI states. Therefore, if the CORESET with the lowest Id and PDSCH are transmitted at different time instances where the gNB is to change the beam, it may be unclear how the beam for PDSCH is determined.

For a P-tracking RS (TRS), the source QCL can be either SSB or CSI-RS for beam management (BM) and should not have a reference to itself as source QCL RS. If the beam used for SSB or CSI-RS for BM varies, it may be unclear which beam should be applied for the reception of P-TRS. For AP-TRS, the source QCL may have to be P-TRS and should not have a reference to itself as source QCL RS. If the beam used for P-TRS changes from one instance to another, it may be unclear which beam should be used. For CSI-RS for CSI measurements (excluding CSI-RS for BM), the source QCL may have to be TRS, TRS+SSB, or TRS+CSI-RS for BM and should not have a reference to itself as source QCL RS. When the beam of the source (TRS, SSB, or CSI-RS) for BM uses a different beam, it may be unclear which one should be applied.

Additionally, periodic CSI-RS (P-CSI-RS) should not have a reference to itself as source) QCL RS. qcl-InfoPeriodicCSI-RS may contain a reference to a TCI state indicating the source QCL RS and QCL type(s). If the TCI state is configured with a reference to an RS configured with qcl-type set to a “typeD” association, that RS may be an SS/physical broadcast channel (PBCH) block (SSB) located in the same or different CC/DL BWP, or a CSI-RS resource configured as periodic located in the same or a different CC/DL BWP. Also, a DMRS of a PDCCH/PDSCH may not be able to have QCL that refers to itself. A UE is not expected to be configured with different TCI-StateIDs for the same aperiodic CSI-RS resource Id configured in multiple aperiodic CSI-RS resource sets with the same triggering offset in the same aperiodic trigger state. This condition should possibly be revised based on how a beam indication using TCI state may not be sufficient. If AP-CSI-RS is transmitted with a time gap that is less than a threshold, a similar procedure to PDSCH scheduled with a time gap less than the threshold may be applied. Except in the case that another DL signal or channel overlaps with AP-CSI-RS, the same beam of the other signal or channel should be applied.

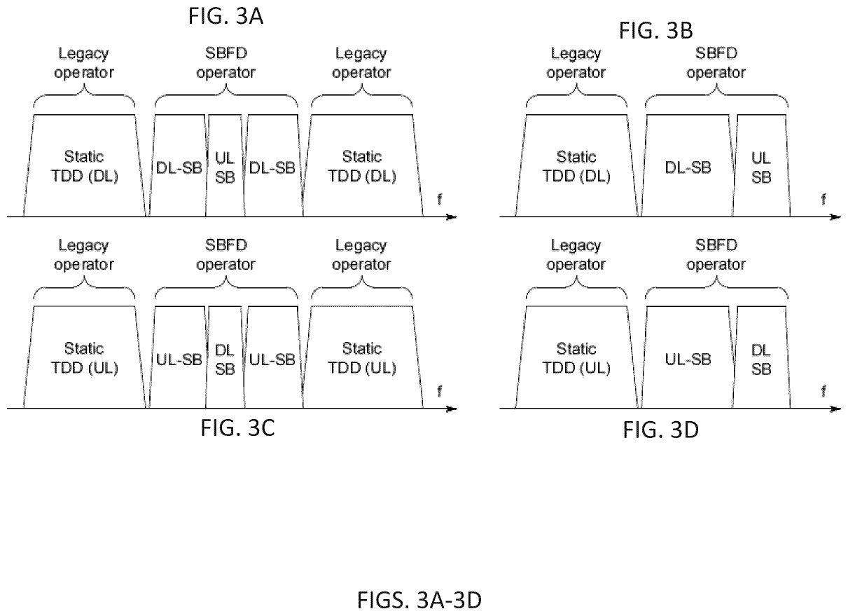

FIGS. 3A-3D illustrate four scenarios of SBFD operation compared to legacy operators using static TDD, according to various embodiments. The x axis in FIGS. 3A-3D represents frequency, and FIGS. 3A-3D illustrate approximate signal transmissions across a frequency spectrum, introducing the use of the SBFD with legacy TDD signal transmissions. FIGS. 3A-3D are examples, and other signal transmission patterns may be implemented in accordance with one or more embodiments of the present disclosure.

Referring to FIG. 3A, the legacy operator uses static TDD for DL, while the SBFD operator places the uplink subband (UL-SB) in the center of its carrier, with two DL subbands (DL-SBs) on either side. This setup allows for concurrent UL and DL transmissions, improving efficiency.

Referring to FIG. 3B, the legacy operator uses static TDD for DL. The SBFD operator places the DL-SB flanked by a UL-SB, enabling simultaneous UL and DL operations.

Referring to FIG. 3C, the legacy operator uses static TDD for UL. The SBFD operator places a DL-SB at the center of the carrier surrounded by UL-SBs, enabling simultaneous UL and DL operations.

Referring to FIG. 3D, the legacy operator uses static TDD for UL. The SBFD operator places the UL-SB flanked by DL SB, enabling simultaneous UL and DL operations.

Accordingly, SBFD can coexist with legacy TDD configurations to achieve the advantages of full duplex communication. The SBFD configurations thus provide enhancements, even when a UE operates in half duplex mode.

In NR, a gNB can use TCI-state to indicate to the UE the QCL source RS and the QCL relationship for a target DMRS port of PDSCH, a DMRS port of PDCCH, and/or a CSI-RS port of a CSI-RS resource. Specifically, the UE may determine that the QCL source RS and the target signal or channel are QCLed with respect to the configured qcl-Type in TCI-State.

Rather than directly using the RS Id(s) provided as part of TCI-state, the UE may interpret the TCI based on the effective RS(s) associated with RS Id(s) provided as part of TCI-state. Determining the effective RS will be described below.

In a full duplex operation mode, the gNB may need to switch between multiple configurations of the antennas or panels depending on whether the P/SP RS occurs in legacy “D” symbols or in SBFD symbols. When a symbol is configured as “D” or designated as a DL symbol, it means that it is primarily intended for the transmission of data from the gNB to the UE. When a symbol or slot is configured as “U” or designated as a UL symbol, it means that it is primarily intended for the transmission of data from the UE to the gNB. “F” symbols may be used for both DL and UL transmissions to support flexible scheduling and efficient use of the spectrum. For transitioning from DL to UL, a special slot(S) comprised of “D”, “F”, and “U” symbols may be used to accommodate the switching time. For network energy saving, the gNB may need switch between multiple configurations of the antennas or panels.

When the gNB uses different beams at different instances of a P/SP RS that is used as a QCL source for other target signals or channels, the UE may divide this P/SP RS into multiple effective signals (or RSs). The P/SP RS can be P/SP CSI-RS, SSB, etc. The number of effective signals may depend on the number of configurations of the antennas or panels from which the gNB can select. In the case of a full duplex operation, two effective RSs can be assumed for each configured QCL source RS in the TCI-state.

An instance of a P/SP RS may refer to one of the multiple occasions in which a P/SP RS is transmitted. For example, a P-CSI-RS may consist of multiple CSI-RS instances where each instance is transmitted in a different time occasion.

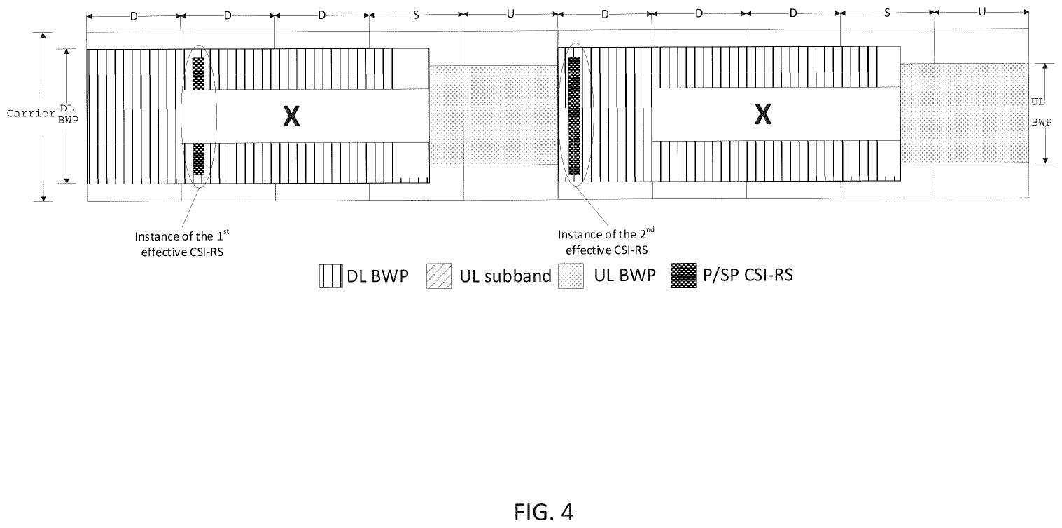

FIG. 4 is a resource grid illustrating an example of a P/SP CSI-RS with a periodicity equal to 4 slots, according to an embodiment.

Referring to FIG. 4, the UL subband is labeled “X”, which denotes that DL is not allowed in the UL subband. The P/SP CSI-RS instances that collide with the UL subband construct the first effective CSI-RS while the instances that do not collide with UL subband construct the second effective CSI-RS.

When this CSI-RS is configured as a QCL source RS in a particular TCI-state Id, the UE may determine that, for the same TCI state Id, the QCL source RS becomes the effective RS based on the deployed configurations of the antennas or panels as a result of a full duplex operation or network energy saving. As described below, the effective CSI-RS to be applied when the TCI state Id is indicated or configured may be determined in different ways.

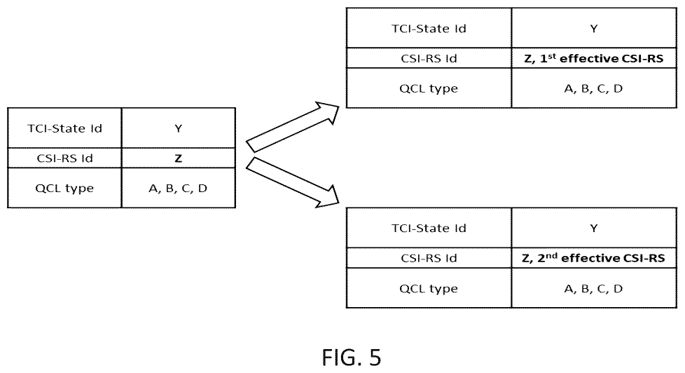

FIG. 5 is a block diagram illustrating conditions in which a TCI state is interpreted relative to the effective CSI-RS rather than the CSI-RS itself, according to an embodiment.

Referring to FIG. 5, an example of TCI state Id “Y” carrying P/SP CSI-RS Id “Z” as a source QCL RS is illustrated. Even though the TCI state Id remains the same, some transmission instances of this P/SP CSI-RS may be performed with particular antenna or panel configurations and other transmission instances may use different configurations of the antennas or panels. In this case, for the same TCI state Id “Y”, there can be two effective QCL source RSs.

A UE may determine the effective RS in the TCI implicitly if the UE is aware of the time instances at which the gNB intends to change the configurations of the antennas or panels being used.

In a full duplex mode, the UE may determine that the instances of the P/SP RS used as a QCL source RS transmitted in “D” or “F” symbols belong to the first effective RS. On the other hand, the UE may determine that the instances of the P/SP RS used as a QCL source RS transmitted in SBFD symbols, i.e., the symbols that can be used for UL transmission and DL transmission, belong to the second effective RS.

In a network energy saving mode, the gNB may change the configurations of the used antennas or panels either dynamically or semi-statically. When the gNB either explicitly or implicitly indicates to the UE when the configurations of the antennas or panels are changed, the UE can determine the effective RS.

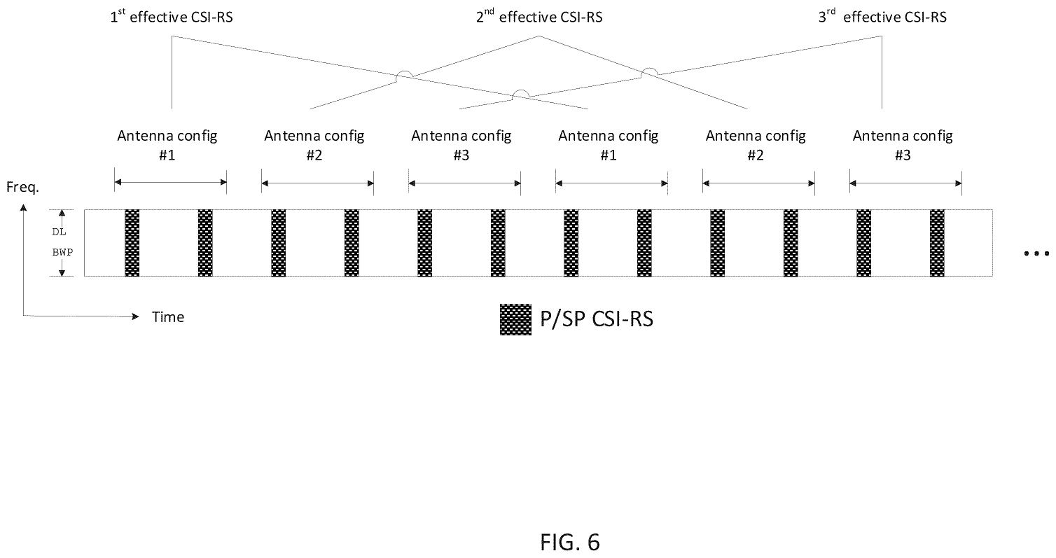

FIG. 6 is a diagram illustrating how the effective CSI-RS associated with different antenna or panel configurations is determined, according to an embodiment.

Referring to FIG. 6, an example in which the gNB uses three different antenna or panel configurations at different time instances is shown. Different antenna or panel configurations can be used to transmit different instances from the same P/SP CSI-RS. In this case, when this P/SP CSI-RS is used as a QCL source in a particular TCI state, the UE may determine there are three effective P/SP CSI-RSs associated with the configured TCI state.

Additionally or alternatively, the gNB may explicitly indicate to the UE the time locations of each effective signal associated with the QCL source RS. For example, the gNB may provide the UE with one or more time patterns via higher layer signaling indicating a periodicity, offset, length, or bitmap that may be repeated. The instance of an P/SP RS that falls within particular time pattern may be used to form an effective QCL source RS.

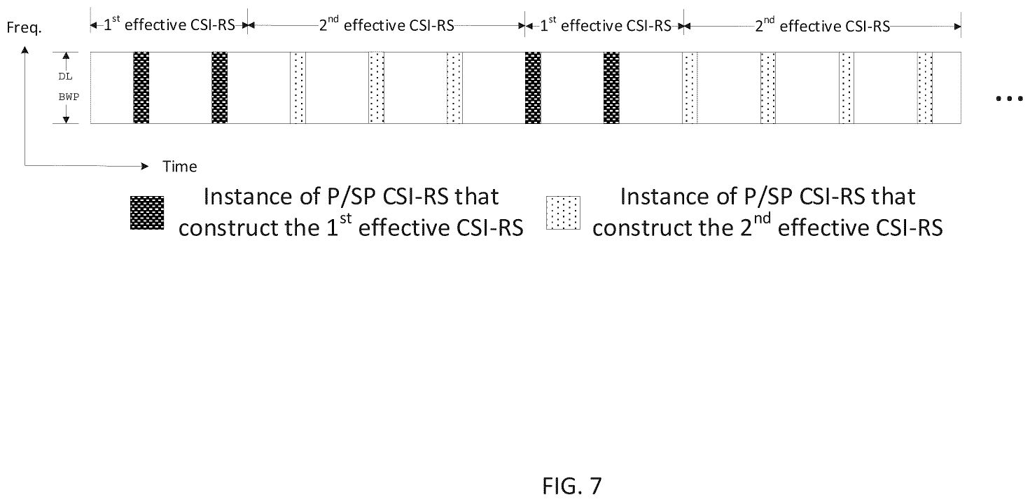

FIG. 7 is a diagram illustrating how the effective QCL source RS is determined based on a configured time window pattern, according to an embodiment.

Referring to FIG. 7, two configured time patterns are shown to determine the 1^{st} and 2^{nd} effective CSI-RS. The time window of different effective CSI-RS may include a different number of CSI-RS instances. In FIG. 7, the time patterns for the 1^{st} and 2^{nd} effective CSI-RSs are contiguous, however they can also be non-contiguous.

Moreover, the gNB may provide the UE with “N−1” time patterns to derive an “N” effective QCL source RS, where instances of the RS that do not belong to any of the configured “N−1” patterns form the Nth effective QCL source RS. For example, in FIG. 7, the gNB may only configure the time pattern for the 1^{st} effective QCL source RS. Then, the remaining time instances of CSI-RS that do not fall in the time pattern of the 1^{st} effective QCL source RS construct the 2^{nd} effective QCL source RS.

When a single instance of P/SP RS includes multiple orthogonal frequency domain multiplexing (OFDM) symbols, an instance may cross the boundaries between the time patterns of two effective RSs. This may occur because of the configuring of a different periodicity or offset for the P/SP RS and the time patterns. In this case, one or more rules may be applied to determine how to label this instance of P/SP RS. The determination may be based on the location of a first or last symbol of this instance of a P/SP RS. For example, if the last symbol of an instance of P/SP RS occurs in the time pattern of the Nth effective RS, then this instance may belong to the Nth effective RS.

The time pattern may start from a particular frame/subframe/slot/symbol, or after applying a particular offset in units of a frame/subframe/slot/symbol, and then this pattern may be repeated for each configured period. Moreover, the gNB may configure multiple patterns by higher layer signaling and may use a MAC-CE and/or DCI to select one of the configured patterns to be applied. The indicated time pattern may be applied after a certain duration such that the UE can process the received indication. For example, in the case of using a MAC-CE based indication, the provided pattern may be applied after the UE transmits a HARQ-ACK of that MAC-CE. For example, the indication may be applied in the first slot after slot n+3Nₛₗₒₜ^{subframe,μ}, where n is the slot for slot HARQ-ACK of MAC-CE. Also, in the case of using an RRC, a particular offset at which the indicator is applied may be signaled through higher layer signaling, may be predefined, or may be defined according to one or more rules as in the case of MAC-CE. In the case of using DCI for indicating the applicable time pattern, a particular time gap may be needed such that the UE can decode the DCI. The time gap may be based on the processing capability of the UE (e.g., processing capability 1 or 2), the timeDurationForQCL indicated by the UE, or beam application time based on unified TCI framework. The value needed to apply the indication time pattern may be predefined or indicated by the UE as part of its capability signaling.

In NR, when a gNB indicates to a UE a particular TCI state to apply, or a UE determines a particular TCI state to apply according to one or more rules, it is clear which QCL source RS should be applied upon the reception the target RS or channel. With the definition of multiple effective QCL source RSs in one or more of the same TCI states, the following procedures can be applied to determine which effective QCL source RS should be applied.

Similar to the implicit rules used for determining the effective QCL source RS, one or more rules can be extended to select one among the effective QCL source RSs determined to be applied on the target RS or channel.

In a full duplex mode, depending on the time location of the target signal or channel, the UE can determine which effective QCL source RS should be applied. Specifically, if the target signal or channel is transmitted in “D” or “F” symbols, the effective QCL source RS that is transmitted in “D” or “F” symbols should be applied. On the other hand, when the target signal or channel is transmitted in SBFD symbols, i.e., the symbols that can be used for UL transmission and DL transmission, the effective QCL source RS that is transmitted in SBFD symbols should be applied.

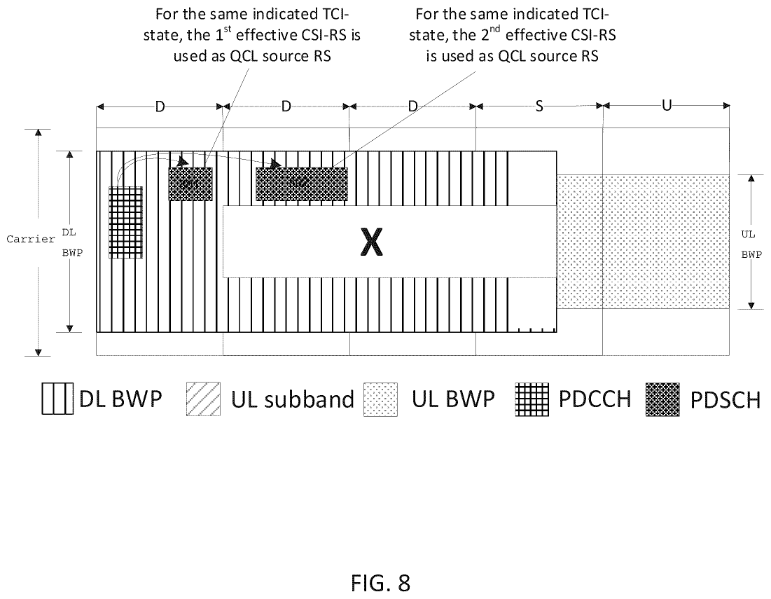

FIG. 8 is a resource grid illustrating an example of determining the effective QCL source RS for the reception of a PDSCH based on an occupied symbol type, according to an embodiment.

Referring to FIG. 8, the UL subband is labeled “X”, which denotes that DL is not allowed in the UL subband. An example of a DCI scheduling two PDSCHs and a single TCI state is indicated. For the PDSCH 801 that is fully confined in the legacy “D” symbols, the 2^{nd} effective CSI-RS is determined to be the QCL source RS. This QCL source RS may be the same as the 2^{nd} effective CSI-RS shown in FIG. 4. For the PDSCH 802 that is fully confined in an SBFD symbol, the 1^{st} effective CSI-RS is determined to be the QCL source RS. This QCL source RS may be the same as the 1^{st} effective CSI-RS shown in FIG. 4.

According to an embodiment, when the gNB explicitly indicates to the UE the time pattern(s) for different effective QCL source RS, using the aforementioned procedure or any other procedure, the UE can determine which effective QCL source RS to apply based on the time location of the target signal or channel.

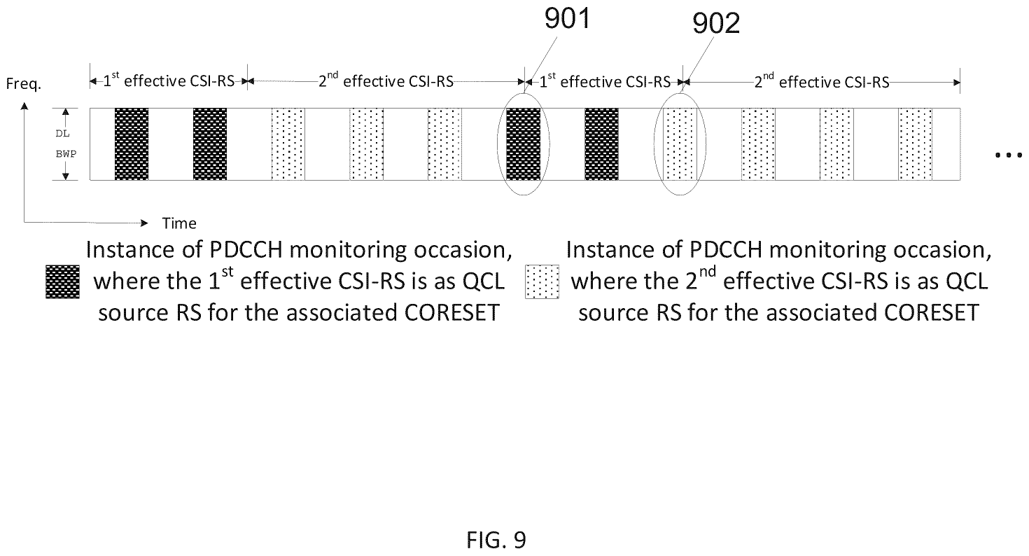

FIG. 9 is a diagram illustrating how the effective QCL source RS for CORESET monitoring is determined, according to an embodiment.

Referring to FIG. 9, a particular P/SP CSI-RS is indicated to be applied as a QCL source RS based on associated CORESETs. According to the configured time pattern(s) for each effective reference CSI-RS, the UE may determine which effective CSI-RS should be applied. Specifically, if the monitoring occasion occurs in the time pattern of the 1^{st} effective CSI-RS, then it is applied as QCL source RS when monitoring PDCCH, and if the monitoring occasion occurs in the time pattern of the 2^{nd} effective CSI-RS, then it is applied as the QCL source RS when monitoring PDCCH.

As shown FIG. 9, the CORESET associated with a particular search space occasion may cross the boundary between two configured patterns which may occur because the CORESET may span more than one symbol and search space monitoring periodicity may differ from the periodicity of time patterns of the effective QCL source RS and/or a different offset may be applied. In this case, one or more rules may be used to determine which effective CSI-RS to apply. For example, the applied effective QCL source RS may be determined based on the location of a last symbol of the target signal or channel. In FIG. 9, the last symbol of the CORESET in PDCCH monitoring occasion 901 occurs in the time pattern of the 1^{st} effective CSI-RS, e.g., the CORESET associated with this search space may consist of two or more OFDM symbols, then it may be determined as the QCL source RS. On the other hand, for PDCCH monitoring occasion 902, the 2^{nd} effective CSI-RS may be determined as the QCL source RS because the last symbol of the CORESET occurs in the time pattern duration of the 2^{nd} effective CSI-RS.

Though FIG. 9 shows how to determine the effective QCL source RS when the CORESET associated with a particular search space occasion may cross the boundary between two configured patterns, the same approach may be extended for other channels or RSs.

The UE may indicate to the gNB whether it supports interpreting the TCI state with respect to the effective RS rather than the RS Id only. This indication may be carried as part of the UE capability signaling. Moreover, the UE may indicate the number of configured or activated TCI states that can be interpreted relative to the effective RS that can be per BWP, per CC, per band, etc.

The gNB can indicate to the UE which TCI state is interpreted with respect to the effective RS rather than just the RS Id. For example, the gNB may configure a flag as part of TCI-state information element (IE) to indicate whether this TCI state is used similar to other NR configurations or if it is a new interpretation based on the effective RS rather than the RS Id only. For example, if the flag is configured or set to 1, the TCI state may be interpreted based on the effective RS rather than the RS Id only. If the flag is not configured (or is absent) or set to 0, the TCI state may be interpreted similar to other NR systems. As another possibility, the gNB can indicate the TCI state Id(s) of the TCI state(s) which are interpreted based on the effective RS rather than RS Id only.

Moreover, the gNB may dynamically indicate whether the legacy TCI state is applied or if a new interpretation based on the effective RS rather than RS Id only is used. For example, the gNB may use MAC-CE to indicate the Id(s) of TCI state(s) that are interpreted based on the effective RS rather than the RS Id only. This indication may be applicable after the UE transmits the HARQ-ACK of that MAC-CE. For example, the indication may be applied in the first slot after slot n+3Nₛₗₒₜ^{subframe,μ} where n is the slot for the HARQ-ACK of the MAC-CE. Also, for the case of using RRC, a particular offset at which the indicator is applied may be signaled through higher layer signaling or predefined, or according to some rules as in the case of the MAC-CE. In the case of using DCI, e.g., group common (GC)-DCI indicating the TCI state(s) with a new interpretation, a particular time gap may be needed for the UE to decode the DCI. The GC-DCI may be based on the processing capability of the UE (processing capability 1 or 2) or the timeDurationForQCL indicated by the UE. The value that may be used to apply the indication time pattern may be predefined, or may be indicated by the UE as part of its capability signaling.

According to an embodiment, the effective RS may also be extended to have an effective TCI state. In this case, the target channel or signal may be linked to at least one TCI state. For example, depending on the time domain location of target channel or signal, the UE may determine which effective TCI state is to be used. The determination may be similar to other procedures described herein to determine the effective RS.

Any particular TCI state may have multiple effective TCI states associated with different effective RSs. The concept of the effective TCI state may be equivalent to the concept of the effective RS. Furthermore, the effective TCI may provide additional flexibility by enabling different QCL type(s), e.g., A, B, C, or D, to be configured separately for each effective TCI state.

In a full duplex operation, there may be two effective TCI states for a TCI state, one to be applied for the target channel or signal when it is transmitted in non-SBFD symbols and another TCI state for when it is transmitted in SBFD symbols. In this case, the gNB may configure two QCL types and the one that is applied may be determined based on which effective TCI state to be applied.

According to another embodiment, the gNB may activate or configure multiple sets of TCI states. Different sets may have TCI states with the same Id or different Ids. For example, for a full duplex operation, the gNB may configure two sets of TCI states, one set to be used to interpret the applicable TCI for transmission or reception in SBFD symbols, and the other set to be used to interpret the applicable TCI for non-SBFD symbols. In addition, if TCI #x is configured or indicated to be applied for the reception PDSCH, PDCCH, CSI-RS, and the like, or for the transmission of PUSCH, PUCCH, SRS, and the like, the time domain location of such a channel or signal may determine which set is to be applied. This may be similar to the RS procedure described herein. For example, if PDSCH is transmitted in SBFD symbols, then TCI #x in the set corresponding to SBFD symbols may be applied. On the other hand, if PDSCH is transmitted in non-SBFD symbols, then TCI #x in the set corresponding to non-SBFD symbols may be applied. Other rules, methods, or procedures may also be used to activate multiple sets of TCI.

In NR, the TCI state to be applied in the case of dynamic PDSCH or AP-CSI-RS may depend on whether or not the scheduling or triggering DCI has a TCI field. Moreover, the applicable TCI state may depend on whether the offset between DL DCI and the corresponding PDSCH is less than or greater than timeDurationForQCL.

In NR, if PDSCH is scheduled with a DCI format that does not have a TCI state, e.g., fallback DCI such as DCI format 1_0, and the time offset between the scheduling DCI and PDSCH is greater than a threshold timeDurationForQCL, the UE may determine that the beam used for reception of PDCCH is applied. In this case, PDCCH and PDSCH may be assumed to be QCLed. When the gNB uses different antennas or panels, the PDCCH of DCI without a TCI field and the corresponding PDSCH may occur at different time instances. In this case, it may be beneficial to clarify the QCL assumption to be applied for PDSCH reception.

According to an embodiment, when DCI does not have a TCI field and the time offset between PDCCH and PDSCH is greater than a threshold, the UE may determine that the TCI state(s) or QCL assumption of the PDSCH are identical to the one applied for the PDCCH.

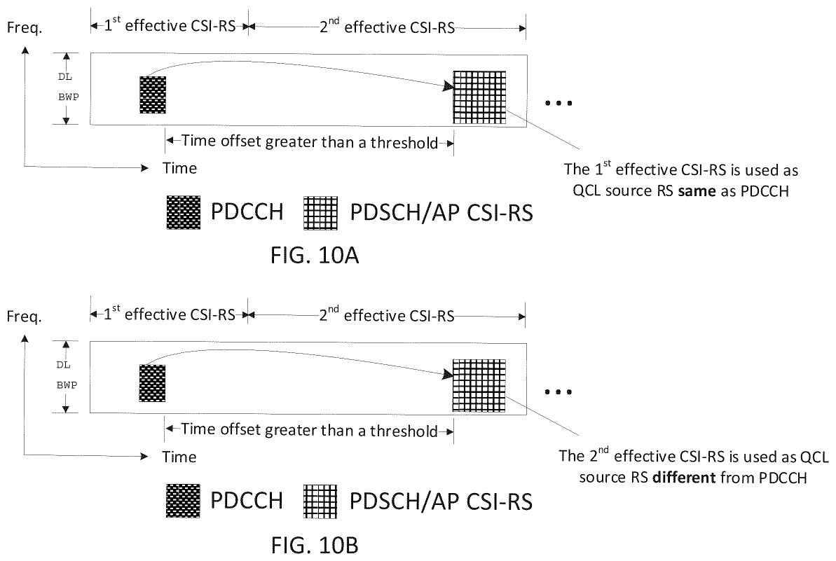

FIGS. 10A-10B are diagrams illustrating how the QCL assumption of the PDSCH scheduled with PDCCH is determined in a case in which a time offset is greater than a threshold, according to various embodiments. In FIGS. 10A-10B, the QCL assumption determination of the PDSCH scheduled with PDCCH may be made without a TCI field, and the time offset between the PDSCH and the PDCCH may be greater than a threshold.

Referring to FIG. 10A, if the 1^{st} effective CSI-RS is determined as the QCL source RS for PDCCH, the UE may also determine the 1^{st} effective CSI-RS to be the QCL source for PDSCH, even if the PDSCH falls in the region of the 2^{nd} effective CSI-RS.

On the other hand, when the DCI does not have a TCI field and the time offset between PDCCH and PDSCH is greater than a threshold, the UE may determine that the QCL source RS depends on which effective QCL source RS should be applied in the time location occupied by the PDSCH.

Referring to FIG. 10B, the PDSCH is confined in the region of the 2^{nd} effective CSI-RS. However, in this case, the UE may determine that the PDSCH has a QCL source RS that is different from the QCL assumption of the scheduling PDCCH (the 1^{st} effective CSI-RS) as the QCL source RS.

According to an embodiment, both the PDCCH and PDSCH may use the same TCI state, but different effective RSs may be used as the QCL source RS. In other words, the TCI of the CORESET carrying the scheduling or triggering PDCCH may determine the applicable TCI for PDSCH reception, but the effective QCL source RS may be determined based on the time domain location of the PDSCH as described herein.

According to an embodiment, regardless of whether or not the DCI has a TCI field, when the time offset between the DCI and the corresponding PDSCH is less than the threshold timeDurationForQCL, predefined rules may be used to determine the applicable QCL assumptions for the PDSCH reception.

For PDSCH scheduled with a time offset less than timeDurationForQCL, the UE may determine that the PDSCH is QCLed with a CORESET with a lowest Id in the latest monitored slot. The CORESET with the lowest Id and the PDSCH may occur at different time instances where the gNB uses different antennas or panels. In this case, it may be beneficial to clarify the QCL assumption to be applied for PDSCH reception.

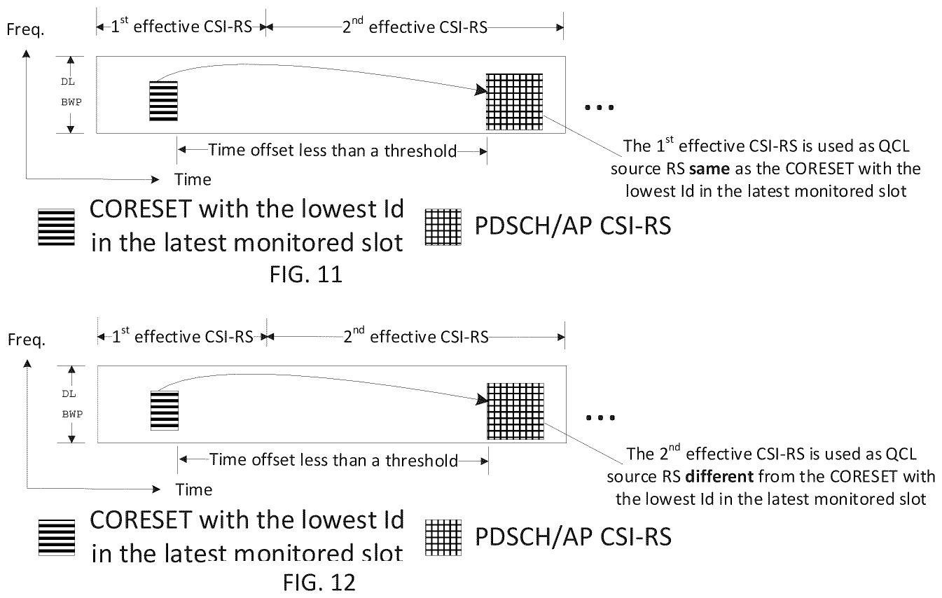

FIGS. 11-12 are diagrams illustrating how the QCL assumption of the PDSCH scheduled with PDCCH is determined in a case in which a time offset is less than a threshold, according to various embodiments. In FIGS. 11-12, the QCL assumption determination of the PDSCH scheduled with PDCCH may be made with or without a TCI field, and the time offset between the PDSCH and the PDCCH may be less than a threshold.

The UE may determine that the QCL for the PDSCH is the same as the effective QCL source RS used for the reception of the CORESET with the lowest Id, even if the time domain location of the PDSCH is in the region of another effective QCL source RS.

Referring to FIG. 11, the QCL for the 1^{st} effective CSI-RS is determined as the QCL source RS for the CORESET with the lowest Id and for the PDSCH even though it falls in the time region of the 2^{nd} effective CSI-RS.

Furthermore, to provide the gNB with more flexibility to use different antenna or panel configurations, the UE may determine that the QCL for the PDSCH is the effective QCL source RS based on the time location of the PDSCH relative to the configured or determined pattern of the effective QCL source RS.

Referring to FIG. 12, the time location of the PDSCH is in the time region for the 2^{nd} effective CSI-RS. Therefore, the UE may determine the 2^{nd} effective CSI-RS as the QCL source RS. In other words, the TCI of the CORESET with the lowest Id in the most recent monitoring slot may determine the applicable TCI for PDSCH reception, and the effective QCL source RS may be determined based on the time domain location of the PDSCH.

Furthermore, the 1^{st} effective CSI-RS and the 2^{nd} effective CSI-RS may correspond to the same TCI state(s) associated with P/SP CSI-RS, where the gNB uses different antennas or panels to transmit different instances of the P/SP CSI-RS as described earlier.

According to an embodiment, when enableDefaultTCI-StatePerCoresetPoolIndex is configured, the aforementioned solutions shown in FIGS. 11-12 may be applied when the time offset between PDSCH and PDCCH is less than a threshold. The difference is that the solutions may be applied for a grouping of CORESETs (per CORESET pool) for determining the effective QCL source RS. Specifically, the PDSCH associated with coresetPoolIndex may be QCLed with the CORESET with the lowest Id among CORESETs, which are configured with the same value of coresetPoolIndex and the effective QCL source RS for the PDSCH may be the same as the one used for the CORESET with the lowest Id among the CORESET with the same coresetPoolIndex. Alternatively, the effective QCL source RS for the PDSCH may be determined based on its time location relative to the time pattern of the effective QCL source RS.

In NR, when enableTwoDefaultTCI is configured, and at least one TCI codepoint indicates two TCI states, and the time offset between PDSCH and PDCCH is less than a threshold, the UE may apply the TCI state corresponding to the lowest codepoint among the TCI codepoints containing two different TCI states based on the activated TCI state in the slot with the first PDSCH transmission occasion. However, as discussed above, the present disclosure proposes, rather than directly applying the determined TCI state, the effective QCL source RS may be determined based on the time location of each PDSCH occasion.

According to an embodiment, if the PDSCH crosses the boundary between the time pattern of two effective RSs, predefined rules may be applied to determine which effective RS is used as the QCL source RS. For example, the location of the first or last symbol of the PDSCH may determine the effective QCL source RS. If the first or last symbol of the PDSCH falls in the region of the Nth QCL source RS, the UE may determine that the Nth QCL source RS is the QCL source RS for PDSCH reception.

Furthermore, one or more of the aforementioned solutions described for PDSCH can be applied to a case in which the PDCCH is triggering an aperiodic CSI-RS when the time offset between PDCCH carrying the triggering DCI and the first symbol of the aperiodic CSI-RS resources in a configured NZP-CSI-RS-ResourceSet is smaller than the UE reported threshold based on beamSwitchTiming or any other reported value.

According to another embodiment, multiple active TCI states sets may also be applied.

According to an embodiment, to support the operation of the gNB switching between different antennas or panels, the gNB may indicate to the UE when there is a change in the antenna or panel configuration, which can activate different TCI states. Different TCI states may be activated using two separate sets. Each set may include multiple TCI states. Specifically, for network energy-saving operations, when the gNB switches between different energy-saving modes and changes its antennas or panels, this may involve switching between different sets of active TCI states or updating multiple QCL source RSs within the same TCI state. In a full duplex operation, a similar behavior can be applied when switching from “D,” “U,” or “F” symbols to SBFD symbols. For example, in the full duplex mode, TCI state Ids {1, 2, 3, 4, 5, 6, 7, 8} can be mapped to the eight codepoints of the TCI field in “D” or “F” symbols, while TCI state Ids {10, 12, 14, 16} may be mapped to the four codepoints of the TCI field in SBFD symbols.

To determine how to interpret the TCI field in the scheduling DCI, several alternatives or combinations thereof may be considered.

According to an embodiment, the size of the TCI field may be fixed and correspond to the largest set among the activated TCI state sets for each antenna or panel configuration. For example, if four TCI states are activated for operation in non-SBFD symbols (i.e., “D,” “U,” or “F” symbols) and two TCI states are activated for operation in SBFD symbols, the TCI field size may be fixed, and its bitwidth may be equal to two bits.

In addition, separate MAC-CEs may be used to activate different sets of TCI states for non-SBFD and SBFD symbols. For instance, a flag in the MAC-CE may indicate whether the activated set of TCI states is for SBFD or non-SBFD symbols. A timeline can be applied in which, when the UE transmits a PUCCH with HARQ-ACK information in slot n corresponding to the PDSCH carrying the activation command, the indicated mapping between TCI states and codepoints of the DCI field Transmission Configuration may be applied starting from the first slot that is after slot n+3Nₛₗₒₜ^{subframe,μ}, where μ is the SCS configuration for the PUCCH.

To determine which set of the activated TCI states is applied to interpret the TCI field, several options may be applied. Based on the PDCCH monitoring occasion, if the PDCCH is transmitted in non-SBFD symbols, the TCI field may be interpreted based on the activated TCI state set for non-SBFD symbols, and if the PDCCH is transmitted in SBFD symbols, the TCI field may be interpreted based on the activated TCI state set for SBFD symbols.

If the PDCCH or the CORESET including the PDCCH crosses the boundary between two configured patterns, predefined rules may be applied to determine which TCI state set is to be used. For example, the time domain location of the first or last symbol of the CORESET in the corresponding search space monitoring occasion may determine which TCI state set is applied. If the CORESET including the PDCCH falls in a non-SBFD symbol, the TCI state set corresponding to non-SBFD may be applied.

In addition, the active TCI state sets may be determined based on the time location of the PDSCH occasion. If the PDSCH occasion is in the SBFD region, the active TCI state set corresponding to SBFD symbols may be applied, and if the PDSCH occasion is in the non-SBFD region, the active TCI state set corresponding to non-SBFD symbols may be applied.

Furthermore, if the PDSCH crosses the boundary between two configured patterns, predefined rules may determine which TCI state set is applied. For instance, the time domain location of the first or last symbol of the PDSCH may determine which TCI state set is applied. If the first or last symbol of the PDSCH falls in a non-SBFD symbol, the TCI state set corresponding to non-SBFD symbols may be applied.

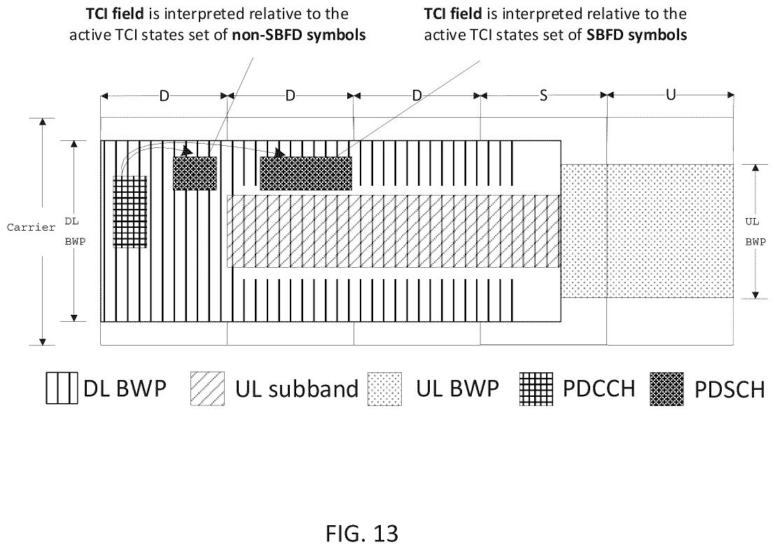

FIG. 13 is a resource grid illustrating an example of interpreting a TCI field based on a time location of a PDSCH occasion, according to an embodiment.

Referring to FIG. 13, a single DCI is used to schedule two PDSCHs using a single TCI field. The first PDSCH is fully confined in non-SBFD symbols, while the second PDSCH is fully confined in SBFD symbols. For the first PDSCH, the indicated TCI code point is interpreted relative to the activated TCI states set for non-SBFD symbols. For the second PDSCH, the indicated TCI code point is interpreted relative to the activated TCI states set for SBFD symbols.

When the activated TCI states sets for SBFD and non-SBFD have different sizes, e.g., 4 activated states for the SBFD and 2 activated states for the non-SBFD, then this may impose a restriction on the gNB, as the gNB has to indicate the first or second codepoint of the TCI field such that the TCI field is mapped to a valid TCI state in all cases.

Therefore, one or more predefined rules can be applied when interpreting the TCI field for the set with fewer active TCI states. For example, the effective codepoint can be calculated as mod (the indicated codepoint, the size of the activated TCI states sets). In addition, if the TCI field in the DCI is set to 2, then it may correspond to the third activated TCI state in the set for non-SBFD and the first TCI state in the set for SBFD.

This approach is similar to having a single TCI state set and two TCI fields in the scheduling DCI. In this case, the first TCI field indicates the TCI for the PDSCH(s) scheduled in SBFD symbols and the second TCI field indicates the TCI state for the PDSCH(s) scheduled in non-SBFD symbols out of the same single activated TCI state set.

Similar to the aforementioned solutions, the time domain location of the PDSCH may determine which TCI field in the scheduling DCI may be applied. For example, if the PDSCH is confined in an SBFD symbol, then the first TCI field is applied. Similar to the aforementioned solutions, the time domain location of PDCCH may determine which TCI field to be applied.

The UE may indicate to the gNB via capability signaling whether it supports having PDCCH with two TCI fields. Additionally, having two TCI fields may be applicable to some DCI formats, but not all of them. For example, non-fallback DCI formats may have two TCI fields. The gNB may configure a flag to indicate which DCI format has two TCI fields. Moreover, the UE may indicate to the gNB via capability signaling which DCI formats support having two TCI fields.

Both TCI fields may have the same number of bits or a different number of bits. The UE may indicate to the gNB via capability signaling whether both TCI fields should have the same size or different sizes.

Additionally, to provide the gNB with more flexibility, there can be two sets of activated TCI states, i.e., one set for PDSCH in SBFD symbols and another set for PDSCH in non-SBFD symbols. In this case, the UE may use the first TCI state set to interpret the indication of the first TCI field and the second TCI state set to interpret the indication of the second TCI field. In this case, the bitwidth of the first TCI field may depend on the size of the first activated TCI state set, and the bitwidth of the second TCI field may depend on the size of the second activated TCI state set. Alternatively, a single bitwidth may be applied to both fields based on the set containing more TCI states, as it may be beneficial for both TCI fields to have the same size. Additionally, the gNB may configure the size of at least one TCI field via higher layer signaling, regardless of whether a single or multiple sets of TCI states are used.

For the case of SPS PDSCH, the same concept can be applied for each SPS PDSCH occasion based on its time domain location to interpret the TCI state field of the activation DCI.

To perform a network energy saving operation, similar solutions may be applied for each energy saving mode. That is, SBFD and non-SBFD may correspond to different energy saving modes. Though the aforementioned examples are focused on PDCCH and PDSCH, similar solutions may be applied for other channels or signals, e.g., PUSCH, CSI-RS and the like.

According to an embodiment, rather than using MAC-CE to activate separate TCI states sets for different antennas or panels, e.g., in SBFD and non-SBFD symbols, or for different energy saving modes, implicit activation or deactivation of additional TCI states sets may occur. For example, if an SBFD operation is deactivated dynamically via MAC-CE or DCI, then one or more additional TCI states sets may be deactivated as well and the corresponding TCI field may no longer exist in the scheduling DCI. The gNB may configure multiple sets of TCI states and when the full duplex operation is activated, the gNB may choose one of the configured TCI sets to be applied. Similarly, in a network energy saving operation, when the gNB transmits an indication of a particular energy saving mode, the corresponding TCI set may be activated or deactivated.

Additionally, the UE may need time to activate the TCI state set in case of implicit indication based on starting or ending a full duplex operation or switching between different energy saving modes. When a MAC-CE is used to trigger a full duplex operation or switch between different energy saving modes, a timeline can be applied in which, when the UE would transmit a PUCCH with HARQ-ACK information in slot n corresponding to the PDSCH carrying the activation command, the indicated mapping between TCI states and codepoints of the DCI field Transmission Configuration Indication should be applied starting from the first slot that is after slot n+3Nₛₗₒₜ^{subframe,μ}, where μ is the SCS configuration for the PUCCH.

If DCI is used to trigger a full duplex operation or switch between different energy-saving modes and activate the corresponding TCI states set, a predefined offset may be defined from the PDCCH carrying this DCI (e.g., a last symbol of the PDCCH) to a particular time instance at which the indicated TCI state is activated (e.g., the first slot after the end of the indicated offset). If the UE transmits a HARQ-ACK signal to this PDCCH, the UE may determine that the TCI state set is applicable after some offset from the transmission of the ACK signal to the PDCCH. The offset value may be predefined or indicated by the UE as part of its capability signaling.

Having multiple active TCI states sets may increase the UE complexity. Therefore, it may be beneficial if the UE indicates to the gNB via capability signaling whether it supports such a feature or not. Moreover, the UE may indicate to the gNB the total number of active TCI states across all the active TCI states sets, or the number of active TCI states in each TCI states set via capability signaling, for example.

Similar solutions may be applied if each TCI state is configured with multiple QCL source RSs and the applicable one is determined based on the configurations of antennas or panels used at the gNB.

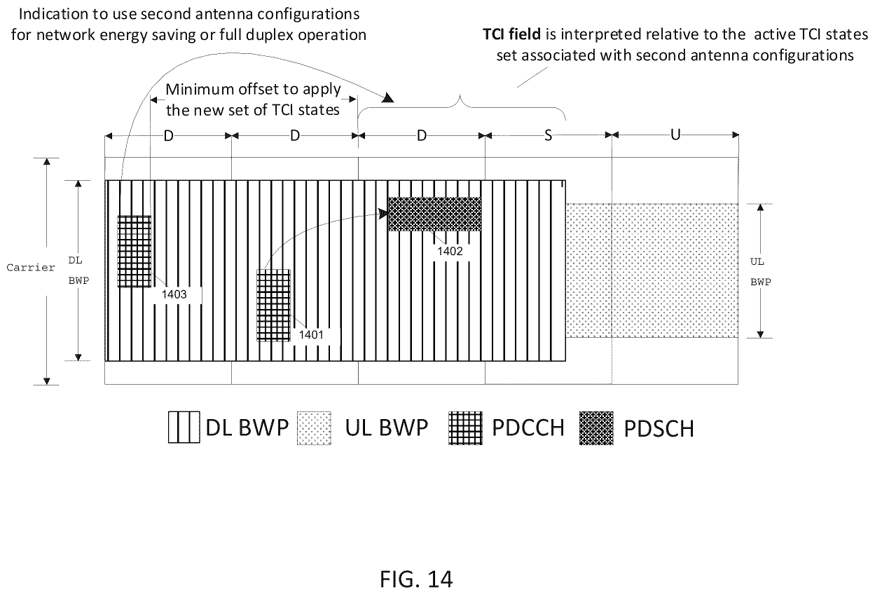

FIG. 14 is a resource grid illustrating a timeline for applying a second set of TCI states, according to an embodiment.

Referring to FIG. 14, within the time window for activating the second set of TCI states based on another antenna configurations for full duplex operation or network energy saving, the gNB may transmit, to the UE, a PDCCH 1401 within this window. A purpose of this PDCCH 1401 may be for scheduling or triggering a DL or UL channel or signal that is to be received or transmitted according to the second set of TCI states, e.g., PDSCH 1402.

According to an embodiment, the UE may use the second set of TCI states to transmit or receive the scheduled or triggered DL or UL channel or signal. This may be beneficial because the gNB may be able to use a proper set of TCI states that is aligned with the deployed antenna configurations because of a network energy saving operation or full duplex operation.

According to an embodiment, this scenario may be considered an error case. In other words, the UE may not expect to receive a PDCCH that schedules or triggers another channel or signal where different sets of TCI states are applied for the PDCCH and the scheduled or triggered channel or signal. This approach is beneficial to ensure that both the gNB and the UE have a common understanding of which TCI states set is used to interpret the configured or indicated TCI state. Additionally or alternatively, the same TCI states set used for the reception of the PDCCH may be applied for the reception or transmission of the scheduled or triggered channel or signal, even if it falls in the region of the second TCI states set. This solution simplifies the UE implementation, as the same TCI states set can be used for both the scheduling PDCCH and the scheduled or triggered channel or RS, avoiding any changes in the configurations associated with scheduling. This solution may also be applied in case that the PDCCH has two TCI fields and a single TCI states set is activated, or the PDCCH has two TCI fields and two TCI states set are activated.

Referring again to FIG. 14, according to an embodiment, the error case may be determined based on the relative positions of PDCCH 1403, which indicates a change in antenna configurations, and PDCCH 1401, which schedules the DL/UL channel or RS, as well as the DL/UL channel or RS triggered by PDCCH 1401, such as PDSCH 1402. For example, the error case may occur if the PDCCH indicating the change in antenna configurations is transmitted after the PDCCH scheduling the DL/UL channel or RS but before the scheduled or triggered channel or RS. This may be considered to be an out-of-order transmission.

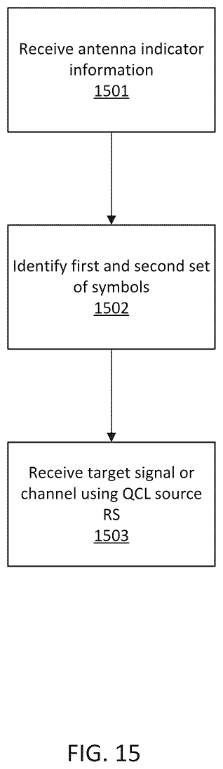

FIG. 15 is a flowchart illustrating a method for determining a QCL source RS to receive a target signal or channel, according to an embodiment.

The method illustrated in FIG. 15 may be performed by a UE or an electronic device. Some or all of the steps described in the figure may be performed in serial or parallel order. Additionally, the order of the steps may vary.

Referring to FIG. 15, antenna indicator information is received in step 1501. The antenna indicator information may be received via a base station and may indicate one or more antenna configurations. The antenna configurations may configure some or all antenna panels to be in an active state.

In step 1502, a first and second set of symbols are identified. The first set of symbols may be identified as symbols at which the first antenna configuration may be applied, and the second set of symbols may be identified as symbols at which the second antenna configuration may be applied.

In step 1503, a target signal or channel is received using a version of a QCL source RS. The target signal or channel may be received based on whether a time instance occurs in the first set of symbols or the second set of symbols.

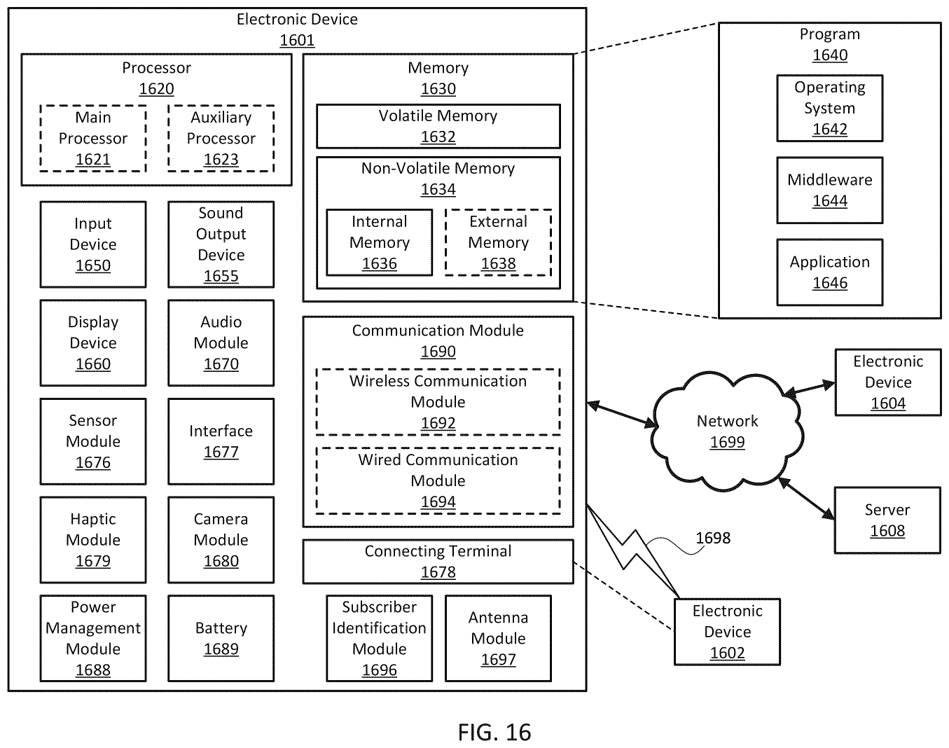

FIG. 16 is a block diagram of an electronic device in a network environment 1600, according to an embodiment.

Referring to FIG. 16, the electronic device 1601 in a network environment 1600 provides a structure for implementing the method described herein. The device can communicate with other devices or servers via different networks, allowing it to receive and process antenna indicator information from a base station or gNB. The processor 1620 and memory 1630 may enable the device to store and execute instructions for identifying QCL CSI-RS, generating effective RSs, and configuring target signals or channels. The communication module 1690 and antenna module 1697 may facilitate the transmission and reception of signals, supporting the SBFD operations described in the claims.

The electronic device 1601 in the network environment 1600 may communicate with an electronic device 1602 via a first network 1698 (e.g., a short-range wireless communication network), or an electronic device 1604 or a server 1608 via a second network 1699 (e.g., a long-range wireless communication network). The electronic device 1601 may communicate with the electronic device 1604 via the server 1608. The electronic device 1601 may include a processor 1620, a memory 1630, an input device 1650, a sound output device 1655, a display device 1660, an audio module 1670, a sensor module 1676, an interface 1677, a haptic module 1679, a camera module 1680, a power management module 1688, a battery 1689, a communication module 1690, a subscriber identification module (SIM) card 1696, or an antenna module 1697. In one embodiment, at least one (e.g., the display device 1660 or the camera module 1680) of the components may be omitted from the electronic device 1601, or one or more other components may be added to the electronic device 1601. Some of the components may be implemented as a single integrated circuit (IC). For example, the sensor module 1676 (e.g., a fingerprint sensor, an iris sensor, or an illuminance sensor) may be embedded in the display device 1660 (e.g., a display).

The processor 1620 may execute software (e.g., a program 1640) to control at least one other component (e.g., a hardware or a software component) of the electronic device 1601 coupled with the processor 1620 and may perform various data processing or computations.

As at least part of the data processing or computations, the processor 1620 may load a command or data received from another component (e.g., the sensor module 1676 or the communication module 1690) in volatile memory 1632, process the command or the data stored in the volatile memory 1632, and store resulting data in non-volatile memory 1634. The processor 1620 may include a main processor 1621 (e.g., a central processing unit (CPU) or an application processor (AP)), and an auxiliary processor 1623 (e.g., a graphics processing unit (GPU), an image signal processor (ISP), a sensor hub processor, or a communication processor (CP)) that is operable independently from, or in conjunction with, the main processor 1621. Additionally or alternatively, the auxiliary processor 1623 may be adapted to consume less power than the main processor 1621, or execute a particular function. The auxiliary processor 1623 may be implemented as being separate from, or a part of, the main processor 1621.

The auxiliary processor 1623 may control at least some of the functions or states related to at least one component (e.g., the display device 1660, the sensor module 1676, or the communication module 1690) among the components of the electronic device 1601, instead of the main processor 1621 while the main processor 1621 is in an inactive (e.g., sleep) state, or together with the main processor 1621 while the main processor 1621 is in an active state (e.g., executing an application). The auxiliary processor 1623 (e.g., an image signal processor or a communication processor) may be implemented as part of another component (e.g., the camera module 1680 or the communication module 1690) functionally related to the auxiliary processor 1623.

The memory 1630 may store various data used by at least one component (e.g., the processor 1620 or the sensor module 1676) of the electronic device 1601. The various data may include, for example, software (e.g., the program 1640) and input data or output data for a command related thereto. The memory 1630 may include the volatile memory 1632 or the non-volatile memory 1634. Non-volatile memory 1634 may include internal memory 1636 and/or external memory 1638.

The program 1640 may be stored in the memory 1630 as software, and may include, for example, an operating system (OS) 1642, middleware 1644, or an application 1646.

The input device 1650 may receive a command or data to be used by another component (e.g., the processor 1620) of the electronic device 1601, from the outside (e.g., a user) of the electronic device 1601. The input device 1650 may include, for example, a microphone, a mouse, or a keyboard.

The sound output device 1655 may output sound signals to the outside of the electronic device 1601. The sound output device 1655 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 1660 may visually provide information to the outside (e.g., a user) of the electronic device 1601. The display device 1660 may include, for example, a display, a hologram device, or a projector and control circuitry to control a corresponding one of the display, hologram device, and projector. The display device 1660 may include touch circuitry adapted to detect a touch, or sensor circuitry (e.g., a pressure sensor) adapted to measure the intensity of force incurred by the touch.

The audio module 1670 may convert a sound into an electrical signal and vice versa. The audio module 1670 may obtain the sound via the input device 1650 or output the sound via the sound output device 1655 or a headphone of an external electronic device 1602 directly (e.g., wired) or wirelessly coupled with the electronic device 1601.

The sensor module 1676 may detect an operational state (e.g., power or temperature) of the electronic device 1601 or an environmental state (e.g., a state of a user) external to the electronic device 1601, and then generate an electrical signal or data value corresponding to the detected state. The sensor module 1676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1677 may support one or more specified protocols to be used for the electronic device 1601 to be coupled with the external electronic device 1602 directly (e.g., wired) or wirelessly. The interface 1677 may include, for example, a high definition multimedia interface (HDMI), a universal serial bus (USB) interface, a secure digital (SD) card interface, or an audio interface.

A connecting terminal 1678 may include a connector via which the electronic device 1601 may be physically connected with the external electronic device 1602. The connecting terminal 1678 may include, for example, an HDMI connector, a USB connector, an SD card connector, or an audio connector (e.g., a headphone connector).

The haptic module 1679 may convert an electrical signal into a mechanical stimulus (e.g., a vibration or a movement) or an electrical stimulus which may be recognized by a user via tactile sensation or kinesthetic sensation. The haptic module 1679 may include, for example, a motor, a piezoelectric element, or an electrical stimulator.

The camera module 1680 may capture a still image or moving images. The camera module 1680 may include one or more lenses, image sensors, image signal processors, or flashes. The power management module 1688 may manage power supplied to the electronic device 1601. The power management module 1688 may be implemented as at least part of, for example, a power management integrated circuit (PMIC).

The battery 1689 may supply power to at least one component of the electronic device 1601. The battery 1689 may include, for example, a primary cell which is not rechargeable, a secondary cell which is rechargeable, or a fuel cell.

The communication module 1690 may support establishing a direct (e.g., wired) communication channel or a wireless communication channel between the electronic device 1601 and the external electronic device (e.g., the electronic device 1602, the electronic device 1604, or the server 1608) and performing communication via the established communication channel. The communication module 1690 may include one or more communication processors that are operable independently from the processor 1620 (e.g., the AP) and supports a direct (e.g., wired) communication or a wireless communication. The communication module 1690 may include a wireless communication module 1692 (e.g., a cellular communication module, a short-range wireless communication module, or a global navigation satellite system (GNSS) communication module) or a wired communication module 1694 (e.g., a local area network (LAN) communication module or a power line communication (PLC) module). A corresponding one of these communication modules may communicate with the external electronic device via the first network 1698 (e.g., a short-range communication network, such as BLUETOOTH™, wireless-fidelity (Wi-Fi) direct, or a standard of the Infrared Data Association (IrDA)) or the second network 1699 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 1692 may identify and authenticate the electronic device 1601 in a communication network, such as the first network 1698 or the second network 1699, using subscriber information (e.g., international mobile subscriber identity (IMSI)) stored in the subscriber identification module 1696.

The antenna module 1697 may transmit or receive a signal or power to or from the outside (e.g., the external electronic device) of the electronic device 1601. The antenna module 1697 may include one or more antennas, and, therefrom, at least one antenna appropriate for a communication scheme used in the communication network, such as the first network 1698 or the second network 1699, may be selected, for example, by the communication module 1690 (e.g., the wireless communication module 1692). The signal or the power may then be transmitted or received between the communication module 1690 and the external electronic device via the selected at least one antenna.

Commands or data may be transmitted or received between the electronic device 1601 and the external electronic device 1604 via the server 1608 coupled with the second network 1699. Each of the electronic devices 1602 and 1604 may be a device of a same type as, or a different type, from the electronic device 1601. All or some of operations to be executed at the electronic device 1601 may be executed at one or more of the external electronic devices 1602, 1604, or 1608. For example, if the electronic device 1601 should perform a function or a service automatically, or in response to a request from a user or another device, the electronic device 1601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 1601. The electronic device 1601 may provide the outcome, with or without further processing of the outcome, as at least part of a reply to the request. To that end, a cloud computing, distributed computing, or client-server computing technology may be used, for example.

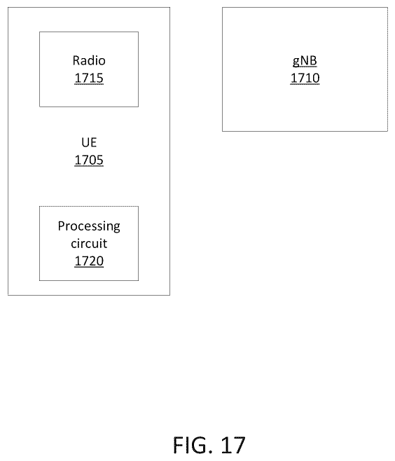

FIG. 17 shows a system including a UE 1705 and a gNB 1710, in communication with each other. The UE may include a radio 1715 and a processing circuit (or a means for processing) 1720, which may perform various methods disclosed herein, e.g., the method illustrated in FIGS. 14-15. For example, the processing circuit 1720 may receive, via the radio 1715, transmissions from the network node (gNB) 1710, and the processing circuit 1720 may transmit, via the radio 1715, signals to the gNB 1710.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Additionally or alternatively, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method performed by a user equipment (UE) for determining a quasi co-located (QCL) source reference signal (RS) to receive a target signal or channel, the method comprising:
receiving antenna indicator information indicating one or more first antenna configurations and one or more second antenna configurations from a base station;
identifying a first set of symbols at which the one or more first antenna configurations are applied and a second set of symbols at which the one or more second antenna configurations are applied; and
receiving the target signal or channel using a version of the QCL source RS at a time instance based on whether the time instance occurs in the first set of symbols or the second set of symbols.

2. The method of claim 1, wherein the antenna indicator information indicates implicitly a time domain location of the one or more first antenna configurations and one or more second antenna configurations based on a time domain location of one or more sub-band full duplex (SBFD) symbols and one or more non-SBFD symbols, or
wherein the antenna indicator information explicitly provides the time domain location of the one or more first antenna configurations and the one or more second antenna configurations.

3. The method of claim 2, wherein the version of the QCL source RS includes a first effective RS for instances of an RS in the one or more first antenna configurations and a second effective RS for instances of the RS in the one or more second antenna configurations generated based on the antenna indicator information, and
wherein the QCL source RS is a periodic or semi-persistent QCL source RS.

4. The method of claim 3, wherein receiving the target signal or channel further comprises applying similar channel properties as the first effective RS or the second effective RS to the target signal or channel based on whether a time domain location of the target signal or channel is in one or more SBFD symbols or one or more non-SBFD symbols.

5. The method of claim 4, wherein in a case in which a scheduling physical downlink control channel (PDCCH) of the target signal or channel does not include a transmission configuration indication (TCI) field and a scheduling gap is greater than or equal to a predefined value, the UE identifies a QCL channel state information (CSI)-RS applied to a physical downlink shared channel (PDSCH) to be the same as a QCL CSI-RS applied to a PDCCH, or
wherein in a case in which the scheduling PDCCH of the target signal or channel does not include the TCI field and the scheduling gap is greater than the predefined value, the UE applies the first effective RS at a time domain location of a PDSCH when the time domain location of the PDSCH is in a time domain location to apply the first effective RS and applies the second effective RS at a time domain location of a PDCCH when the time domain location of the PDCCH is in a time domain location to apply the second effective RS.

6. The method of claim 2, further comprising:
determining the version of the QCL source RS based on at least one set of transmission configuration information (TCI) states including a first set of TCI states and a second set of TCI states,
wherein the first set of TCI states corresponds to the one or more first antenna configurations and the second set of TCI states corresponds to the one or more second antenna configurations.

7. The method of claim 6, wherein receiving the target signal or channel further comprises using the first set of TCI states or the second set of TCI states based on whether the time instance of the target signal or channel is in a time domain location of the one or more first antenna configurations or the one or more second antenna configurations.

8. The method of claim 6, wherein a first medium access control-control element (MAC-CE) activates the first set of TCI states and a second MAC-CE activates the second set of TCI states.

9. The method of claim 6, wherein determining the version of the QCL source RS further comprises determining the version of the QCL source RS based on a scheduling physical downlink control channel (PDCCH) including a single TCI field or a PDCCH including two TCI fields.

10. The method of claim 9, wherein in a case the PDCCH includes the single TCI field, a size of the single TCI field is fixed for the first set of TCI states and the second set of TCI states, or
in a case the PDCCH includes two TCI fields, a size of a first TCI field included in the two TCI fields is determined based on the first set of TCI states and a size of a second TCI field included in the two TCI fields is determined based on the second set of TCI states.

11. A user equipment (UE), comprising:
a memory device, and
a processor configured to execute instructions stored on the memory device, wherein the instructions cause the processor to:
receive antenna indicator information indicating one or more first antenna configurations and one or more second antenna configurations from a base station;
identify a first set of symbols at which the one or more first antenna configurations are applied and a second set of symbols at which the one or more second antenna configurations are applied; and
receive a target signal or channel using a version of the quasi co-located (QCL) source reference signal (RS) at a time instance based on whether the time instance occurs in the first set of symbols or the second set of symbols.

12. The UE of claim 11, wherein the antenna indicator information indicates implicitly a time domain location of the one or more first antenna configurations and one or more second antenna configurations based on a time domain location of one or more sub-band full duplex (SBFD) symbols and one or more non-SBFD symbols, or
wherein the antenna indicator information explicitly provides the time domain location of the one or more first antenna configurations and the one or more second antenna configurations.

13. The UE of claim 12, wherein the version of the QCL source RS includes a first effective RS for instances of an RS in the one or more first antenna configurations and a second effective RS for instances of the RS in the one or more second antenna configurations generated based on the antenna indicator information, and
wherein the QCL source RS is a periodic or semi-persistent QCL source RS.

14. The UE of claim 13, wherein the processor is further configured to:
receive the target signal or channel by applying similar channel properties as the first effective RS or the second effective RS to the target signal or channel based on whether a time domain location of the target signal or channel is in one or more SBFD symbols or one or more non-SBFD symbols.

15. The UE of claim 14, wherein in a case in which a scheduling physical downlink control channel (PDCCH) of the target signal or channel does not include a transmission configuration indication (TCI) field and a scheduling gap is greater than or equal to a predefined value, the UE identifies a QCL channel state information (CSI)-RS applied to a physical downlink shared channel (PDSCH) to be the same as a QCL CSI-RS applied to a PDCCH, or
wherein in a case in which the scheduling PDCCH of the target signal or channel does not include the TCI field and the scheduling gap is greater than the predefined value, the UE applies the first effective RS at a time domain location of a PDSCH when the time domain location of the PDSCH is in a time domain location to apply the first effective RS and applies the second effective RS at a time domain location of a PDCCH when the time domain location of the PDCCH is in a time domain location to apply the second effective RS.

16. The UE of claim 12, wherein the processor is further configured to:
determine the version of the QCL source RS based on at least one set of transmission configuration information (TCI) states including a first set of TCI states and a second set of TCI states,
wherein the first set of TCI states corresponds to the one or more first antenna configurations and the second set of TCI states corresponds to the one or more second antenna configurations.

17. The UE of claim 16, wherein the processor is further configured to:
receive the target signal or channel using the first set of TCI states or the second set of TCI states based on whether the time instance of the target signal or channel is in a time domain location of the one or more first antenna configurations or the one or more second antenna configurations.

18. The UE of claim 16, wherein the processor is further configured to:
use a first medium access control-control element (MAC-CE) to activate the first set of TCI states and a second MAC-CE to activate the second set of TCI states.

19. The UE of claim 16, wherein the processor is further configured to:
determine the version of the QCL source RS based on a scheduling physical downlink control channel (PDCCH) including a single TCI field or a PDCCH including two TCI fields.

20. The UE of claim 19, wherein in a case the PDCCH includes the single TCI field, a size of the single TCI field is fixed for the first set of TCI states and the second set of TCI states, or
in a case the PDCCH includes two TCI fields, a size of a first TCI field included in the two TCI fields is determined based on the first set of TCI states and a size of a second TCI field included in the two TCI fields is determined based on the second set of TCI states.
